(19) United States
(12) Patent Application Publication
(10) Pub. No.: US 2010/0240477 A1
(43) Pub. Date: Sep. 23, 2010

(54) SPORTS STICK STRUCTURE

(76) Inventors: Stephen J. Davis, Newtown, PA (US); Roberto Gazzara, Venato (IT); Mauro Pezzato, Treviso (IT); Mauro Pinaffo, Padua (IT); Michele Pozzobon, Treviso (IT)

Correspondence Address: ABELMAN, FRAYNE & SCHWAB, 666 THIRD AVENUE, 10TH FLOOR, NEW YORK, NY, 10017, US

(21) Appl. No.: 12/733,039

(22) PCT Filed: Aug. 21, 2008
(86) PCT No.: PCT/IB2008/053357

§ 371 Date: Jun. 1, 2010

(30) Foreign Application Priority Data
Aug. 24, 2007 (EP) 07114941.3

(51) Int. Cl. A63B 59/14; B23P 17/00; B23P 11/00

(52) U.S. Cl. 473/560; 29/592; 29/428

(57) ABSTRACT

A sports stick structure (10) comprising a handle (12) and a striking end (34) adapted to contact and propel an object The handle comprises a hollow tube having one or more ports (58) extending through opposite faces of said hollow tube. Each port is defined at partially by internal walls formed at the opposite faces of said hollow tube.

The present invention relates to an improved sports stick structure.

Sports sticks, for example hockey sticks, have traditionally been made from wood. A wood stick is solid and can be made from a multi ply lamination in order to improve strength. Wood has been a convenient and traditional material to use but it is limited in strength and weight.

Recent developments have improved sports sticks by making them out of metal such as aluminum. Such sticks are typically made from a one piece extruded aluminum tube, to which a blade and handle can be attached. The hollow tubular construction offers a lighter weight and also easy attachment for the blade and handle.

More recent sports stick structures adopt composite materials such as fiber reinforced resins like carbon fiber in an epoxy resin. These sticks are tubular in form to maximize strength and minimize weight.

Composite materials are attractive alternatives, because a large selection of fiber types and resin types is possible to make available a multitude of options, which have the advantage of being stiffer, stronger, and less susceptible to environmental changes than more traditional materials.

An early example of using composite materials for sports sticks is U.S. Pat. No. 4,086,115 to Sweet, which discloses a tubular hockey stick manufactured using fiberglass fibers in a polyester resin made using a pultrusion process.

U.S. Pat. Nos. 5,419,553 and 5,303,916 to Rogers disclose an improved hockey stick made from composite materials, also made by means of a pultrusion process, with the addition of specific fiber orientation in order to improve the stiffness and strength of the stick.

A pultrusion process has also been used to create sports sticks of two tubes with an internal wall in between.

U.S. Pat. Nos. 5,549,947, 5,688,571, 5,888,601, 6,129,962 to Quigley, et. al., describe a continuous manufacturing operation to produce a hockey stick with continuous fiber reinforcement.

The limitations of making sports sticks using a pultrusion process are that fiber placement cannot be changed along the length of the structure and the cross-section cannot be varied along its length.

U.S. Pat. No. 5,636,836 to Carroll, U.S. Pat. No. 5,746,955 to Calapp, U.S. Pat. No. 6,865,696 to Calapp, and U.S. Pat. No. 6,241,633 to Conroy all describe tubular hockey sticks made from fiber reinforced resin materials with specific fiber orientation in order to achieve desired performance characteristics.

There are several patent applications that describe sports sticks with molded openings on the handle, said openings being referred to as “ports” in the following.

U.S. patent application Ser. No. 11/752,574 (which is a continuation of U.S. patent application Ser. No. 11/183,585) to Davis describes a composite hockey stick with molded ports.

U.S. patent application Ser. No. 11/584,197 to Davis, et. al., describes a multiple tube composite hockey stick where the tubes are separated to form ports.

U.S. patent application Ser. No. 11/584,198 to Davis, et. al., describes a single tube composite hockey stick where ports are formed by cutting holes in the tube and a subsequent molding operation forms the ports.

The present invention relates to a sports stick structure, where the handle is formed of a single, hollow tube having at least one, and preferably a series, of “ports” that extend through the hollow handle tube.

At least one of said ports is defined at least partially by internal walls formed at the opposite faces of the hollow tube

Preferably, each port is formed by a hollow sleeve, which has a peripheral wall that extends between opposed holes in the hollow handle tube.

The opposite ends of the sleeve are inserted between the internal walls defining the port and preferably bonded to them at said opposed holes.

Preferably, each port is shaped to act as opposing arches that provide additional strength, stiffness, comfort, and aerodynamic benefits.

The present invention also relates to an improved method of constructing a sports stick structure with one or more ports, which is more economical and provides a wider range of performance options in terms of stiffness, strength, vibration damping and appearance.

The sports stick structure, according to the invention, may be easily and efficiently manufactured at a low cost with regard to both materials and labor.

The sports stick structure, according to the invention, is of durable and reliable construction and it can provide specific stiffness zones at various orientations and locations along the length of the handle.

The sports stick structure, according to the invention, has superior strength and fatigue resistance, improved shock absorption and vibration damping characteristics, improved aerodynamics, a unique look and improved aesthetics.

For a better understanding of the invention and its advantages, reference should be made to the accompanying drawings and descriptive matter in which there are illustrated preferred embodiments of the invention.

In the attached drawings,

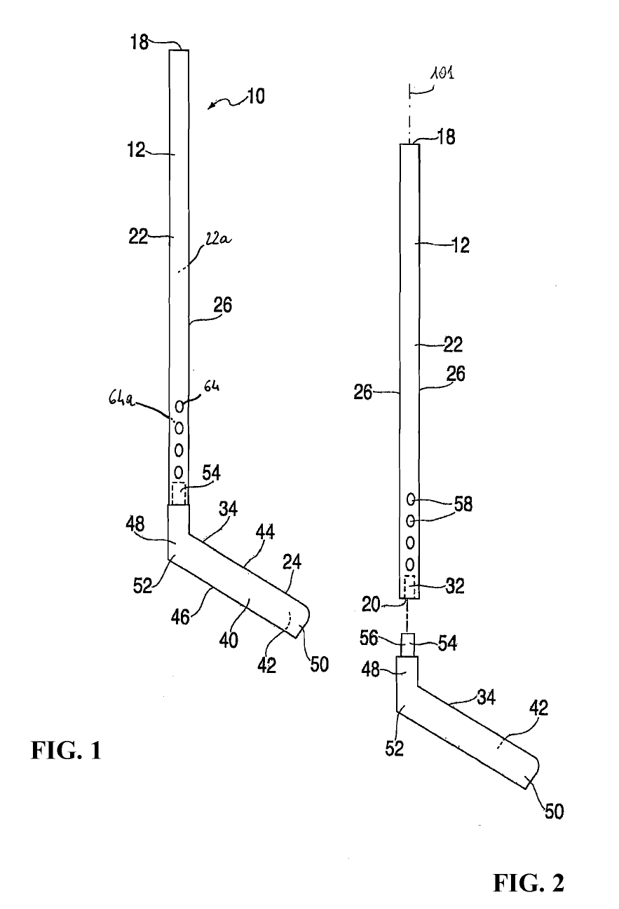

FIG. 1 is a front elevational view of the sports stick structure, according to the invention; and

FIG. 2 is an exploded front elevational view of the sports stick structure shown in FIG. 1; and

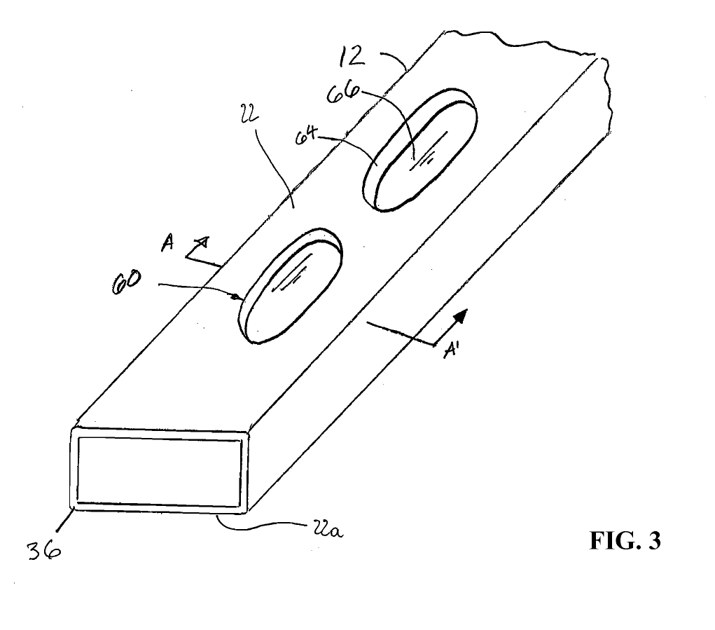

FIG. 3 is an isometric view of a handle portion during a manufacturing step to form the sports stick structure, according to the invention; and

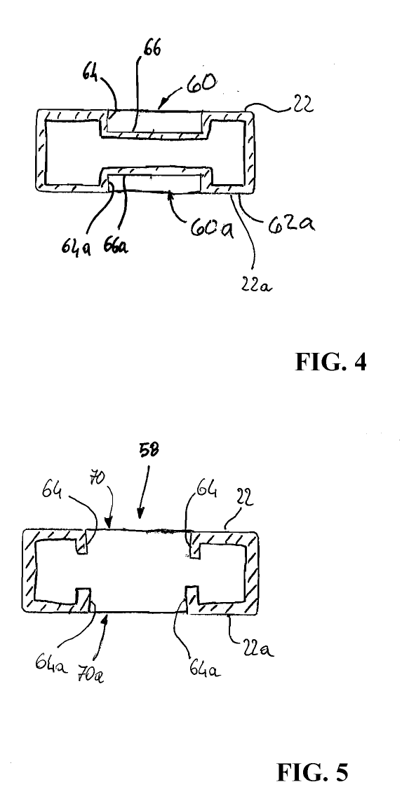

FIG. 4 is a sectional view of the handle portion shown in FIG. 3; and

FIG. 5 is a sectional view of the handle portion of FIG. 4 during a further manufacturing step to form the sports stick structure, according to the invention; and

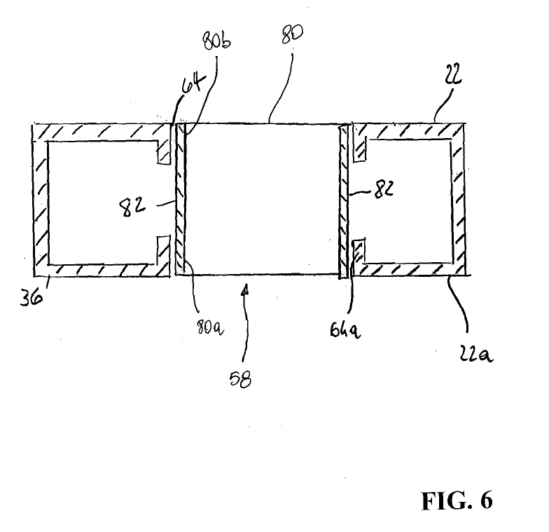

FIG. 6 is a sectional view of the handle portion of FIG. 4 during a further manufacturing step to form the sports stick structure, according to the invention; and

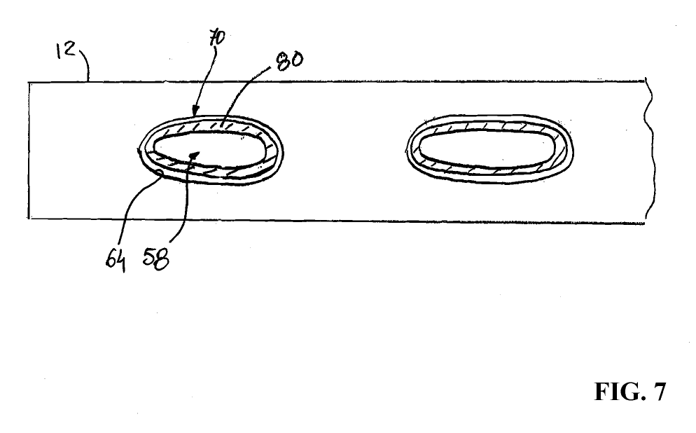

FIG. 7 is an top view of a handle portion of the sports stick structure of FIGS. 1-2.

The same reference numerals refer to the same parts throughout the various Figures.

With reference to the cited drawings, the present invention relates to a sports stick structure 10 that is featured to improve flexibility, strength and other playing characteristics.

The sports stick structure 10 comprises a handle 12 and a striking end 34, i.e., a blade.

The handle 12 is preferably fabricated of a composite material and preferably it comprises multiple layers of aligned carbon filaments held together with an epoxy binder, i.e., so-called “graphite” material. The fibers in the various plies are parallel to one another, but the various plies preferably have varying fiber orientations.

The handle 12 is formed by a hollow tube 36 (FIG. 3), preferably having a rectangular configuration with a top end 18, a bottom end 20, a front face 22, a rear face 22a opposite the front face, and a pair side faces 26.

The handle 12 has a recessed opening 32 in the bottom end 20 thereof for attaching the blade 34.

The blade 34 is preferably also fabricated in a composite material and it comprises multiple layers of aligned carbon filaments held together with an epoxy binder. However, the plies of the blade 34 may have different fiber orientations than the handle 12.

The blade 34 has a generally thin rectangular configuration with a first face 40, a second face 42, an upper edge 44, a lower edge 46, a near end 48, and a far end 50.

The near end 48 has a bend 52 at an angle between 45 and 80 degrees (being preferably 65 degrees) measured between the side faces 26 of the handle end 20 and the upper edge 44 and the lower edge 46 of the blade 34.

The near end 48 of the blade 34 has a male fitting 54 extending therefrom, which is adapted to couple into the opening 32 in the bottom end 20 of the handle 12.

An adhesive 56 couples the stick handle 12 with the blade 34 between the connecting fitting 54 and the opening 32 in the stick handle 12.

It is also possible to form the handle 12 and the blade 34 as one piece forming a complete one piece stick structure.

One or more ports are formed in the handle 12, preferably near the bottom end 20 and between the front face 22 and the rear face 22a.

At least one port 58 is defined at least partially by internal walls 64, 64a formed at the opposite faces 22, 22a of the hollow tube 36.

Preferably, the internal walls 64, 64a extend vertically from the faces 22, 22a towards the interior of the hollow tube 36.

Preferably, the port 58 is formed by a hollow sleeve 80 that extends through a pair of holes 70,70a at the opposite faces 22, 22a of the hollow tube 36.

The port 58 is preferably oval in shape, with the long axis of the oval in line with the longitudinal axis 101 of the handle 12 (FIG. 2).

Preferably, the sleeve 80 is cylindrically shaped and it comprises a peripheral wall 82 that forms the peripheral wall of the port 58 between the opposing faces 22, 22a of the hollow tube 36.

The sleeve 82 is advantageously inserted between the internal walls 64, 64a, even without bonding.

The sleeve 82 has opposite ends 80a, 80b that may be bonded at least partially to the internal walls 64, 64a at the opposite faces 22, 22a of the hollow tube 36.

Preferably, a plurality of ports 58 is formed, which preferably are in the shape of double opposing arches.

This allows the sports stick structure 10 to deflect (deforming the ports 58) and return with more resiliency. The ports 58 thus allow greater bending flexibility than would traditionally be achieved in a single tube design.

The stick structure 10 can also improve comfort by absorbing shock and damping vibrations due to the deformation of the ports 58.

Finally, the ports 58 can improve aerodynamics by allowing air to pass through the handle 12 to reduce the wind resistance and improve maneuverability.

The sports stick structure 10 is preferably manufactured by means of a process that will be described in the following.

At a first step the hollow tube 36 is formed.

The hollow tube 36 of the handle 12 is preferably made from a long fiber reinforced prepreg type material.

Traditional lightweight composite structures have been made by preparing an intermediate material known as a “prepreg” which will be used to mold the final structure.

A prepreg is formed by embedding the fibers, such as carbon, glass, and others, in resin. This is typically done using a prepreg machine, which applies the non-cured resin over the fibers so they are all wetted out.

The resin is at an “B Stage” meaning that only heat and pressure are required to complete the cross linking and harden and cure the resin.

Thermoset resins like epoxy are popular because they are available in liquid form at room temperature, which facilitates the embedding process.

A thermoset is created by a chemical reaction of two components, forming a material in a nonreversible process.

Usually, the two components are available in liquid form, and after mixing together, will remain a liquid for a period of time before the crosslinking process begins.

It is during this “B Stage” that the prepreg process happens, where the resin coats the fibers.

Common thermoset materials are epoxy, polyester, vinyl, phenolic, polyimide, and others.

The prepreg sheets are cut and stacked according to a specific sequence, paying attention to the fiber orientation of each ply.

Each prepreg layer comprises an epoxy resin combined with unidirectional parallel fibers from the class of fibers including but not limited to carbon fibers, glass fibers, aramid fibers, and boron fibers.

The prepreg is cut into strips at various angles and laid up on a table.

The strips are then stacked in an alternating fashion such that the fibers of each layer are different to the adjacent layers. For example, one layer may be +30 degrees, the next layer −30 degrees. If more bending stiffness is desired, a lower angle such as 20 degrees can be used. If more torsional stiffness is desired, a higher angle such as 45 degrees can be used. In addition, 0 degrees can be used for maximum bending stiffness, and 90 degrees can be used to resist impact forces and to maintain the geometric structural shape of the tube.

This lay-up, which comprises various strips of prepreg material, is then rolled up into a tube.

A thin walled polymeric bladder is then inserted into the tube. This bladder will be used to internally inflate the tube when placed in the mold.

The tube is then packed into a mold which forms the shape of the sports stick handle. If the mold and tube are longer than the final desired dimension of the sports stick handle, a final cut to length operation can be performed on the handle 12 after molding.

Air fittings are applied to the interior of the bladder. Preferably, the bladder is closed on the other end of the handle. The mold is then closed over the tube and placed in a heated platen press. For epoxy resins, the temperature is typically around 350 degrees F. While the mold is being heated, the tube is internally pressurized, which compresses the prepreg material and forces the tube to assume the shape of the mold. At the same time, the heat cures the epoxy resin.

The composite material used is preferably carbon fiber reinforced epoxy because the objective is to provide reinforcement at the lightest possible weight.

Other fibers may be used such as fiberglass, aramid, boron and others.

Other thermoset resins may be used such as polyester and vinyl ester. Thermoplastic resins may also be used such as nylon, ABS, PBT and others.

As shown in FIG. 3, after molding, the hollow tube 36 has one or more pairs of recessed areas 60, 60a located on the flat front surface 22 and rear surface 22a, respectively. Each pair of recessed areas is positioned corresponding to a port 58 to be formed.

The recessed areas 60, 60a are preferably oval in shape with cylindrical internal walls 64, 64a and bottom walls 66, 66a, respectively.

FIG. 4 is a sectional view of the stick handle 12 taken along the lines A-A′ in FIG. 3.

Recessed area 60 is located on the front surface 22, and a corresponding recessed area 60a is located on the rear surface 22a, directly opposite recessed area 60.

The next step in the manufacturing process is to remove the bottom walls 66, 66a of the recessed areas 60, 60a. This is typically done by a machining operation to remove the material. The material may also be removed by stamping, laser cutting, water jet cutting or other means. FIG. 5 shows the sectional view of FIG. 4 with the bottom walls 66 and 66a removed, creating holes 70 and 70a. The internal walls 64 and 64a, previously molded during the formation of the recessed areas 60, 60a, are instead retained.

It should be noticed from FIG. 5 that at least a port 58 is at least partially defined by the internal walls 64, 64a that are thus obtained at the opposite faces 22, 22a of the hollow tube 36.

It should be also noticed that the walls 64, 64a add strength and stiffness to the hollow tube 36.

Preferably, a cylindrically shaped sleeve 80 with a continuous cylindrical wall 82 is inserted between the internal walls 64 and 64a.

The ends 80a, 80b of the sleeve 80 form the continuous oval shape of the port 58 and are preferably bonded to the internal walls 64, 64a. Preferably, the ends 80a, 80b of the sleeve 80 are bonded in a continuous manner to the internal walls 64, 64a. An adhesive such as epoxy or other suitable adhesive shall be used to this aim.

The peripheral wall 82 of the sleeve 80 thus extends from the front surface 22 to the rear surface 22a of the hollow tube 36.

FIG. 7 is a top view of a portion of the stick handle 12 showing the ports 58 formed by bonding the sleeve 80 to the hole 70 along the inner walls 64.

Given the presence of the ports 58 at the handle 12, the stick 10 becomes much more aerodynamic because the frontal area is significantly reduced. This is a great benefit to a sports stick since it is long in length and can be difficult to generate fast swing speeds.

Having aerodynamic ports 58 in the handle 12 can significantly reduce aerodynamic drag. The size and spacing of each port 58 can vary according to desired performance parameters. The orientation, or axis of the ports is in line with the swing direction of the shaft therefore maximizing the aerodynamic benefit.

The size and spacing of the ports 12 can affect the stick stiffness in a desirable way. The ports 58 can direct the flex-point of the handle 12 toward its lower portion if desired. A sports stick with a lower flex point is said to provide more velocity to the shot.

An unexpected benefit of the ports 58 in the handle 12 is that they actually improve the durability and strength of the stick structure 10. This is because they act as arches to distribute the stress and strain in a very efficient manner.

The manufacturing method to form the stick structure 10 is much easier and less expensive with respect to those of the prior art because a single tubular structure is molded.

Further, material must be removed to form the holes 70, 70a, which can reduce the strength of the structure. However, the internal walls 64 and 64a add additional reinforcement, acting as an internal columnar support to the structure 10, increasing the strength over a conventional stick.

This reinforcing effect may be further increased by if a sleeve 80 in inserted between the walls 64 and 64a.

Finally, the cylindrical sleeves 80 give the possibility of forming ports 58 of different materials with respect to the stick handle 12. This creates more performance options over other known ported structures. For example, the sleeves 80 may be polymeric such as polyamide, ABS, acrylic, chopped fiber reinforced plastics or other similar materials.

The sleeves 80 may be injection molded in appealing shapes that may be difficult to form with fiber reinforced composites molding methods.

The sleeves 80 may be metallic, to increase rigidity or provide a unique aesthetic.

Alternatively, the sports stick structure 10 can be molded as a one piece structure with the blade 34 attached, therefore producing an entire stick.

In this case, no joints between the shaft and the blade and the stick 10 are formed with longer prepreg tubes, which are joined to the blade construction prior to molding. The entire stick 10 with all components (shaft and blade) is molded together in one operation.

The method according to the invention provides a means of locating ports closer to the blade portion to achieve even greater aerodynamic advantages

It is also possible to have a pre-cured (or molded) blade 34, which is then placed in a mold for bonding to the prepreg shaft as it is cured.

It is also possible to have a pre-cured (or molded) handle 12 and blade 34, then place both into a mold with prepreg reinforcements wrapped around the joint or interface between the shaft and blade in order to make a one piece unit.

It is also possible to use a metal material for the hollow tube 36 such as aluminum, and form the recessed areas using a forging or pressing operation. A step of removing the bottom surfaces 66, 66a of the recessed areas 60, 60a would then follow. The steps of inserting the sleeves 80 the internal walls 64 and 64a and the step of bonding said sleeves to said internal walls to form ports 58 may be foreseen as previously shown.

The sports stick structure of the present invention is particularly suitable for ice hockey but it is not limited to this sports activity.

It can also be applied to field hockey, since the aerodynamic benefits have a greater potential with field hockey because the frontal width of field sports sticks is much greater than ice sports sticks.

The sports stick structure, according to the invention, may be used as a lacrosse stick. Lacrosse sticks are very long in length and therefore carry significant frontal area and would benefit from the improved aerodynamics offered by the ports 58.

The sports stick structure, according to the invention, can also be applied to sports like floorball, in which sticks are used in a similar manner to ice sports sticks.

1. A Sports stick structure (10) comprising a handle (12) and a striking end (34) adapted to contact and propel an object, said handle comprising a hollow tube (36) having one or more ports extending through opposite faces (22, 22a) of said hollow tube, characterized in that at least one port (58) is at least partially defined by internal walls (64, 64a) formed at the opposite faces of said hollow tube.

2. A sports stick structure according to claim 1, characterized in that said internal walls extend vertically from the opposite faces of said hollow tube towards the interior of said hollow tube.

3. A sports stick structure according to claim 1, characterized in that said port is formed by a hollow sleeve (80) extending through the opposite faces (22, 22a) of said hollow tube.

4. A sports stick structure according to claim 3, characterized in that said sleeve comprises a peripheral wall (82) that extends between the opposite faces of said hollow tube to form a peripheral wall of said port.

5. A sports stick structure according to claim 3, characterized in that said sleeve extends through a pair of holes (70, 70a) obtained at opposite faces (22, 22a) of said hollow tube.

6. A sports stick structure according to claim 3, characterized in that said sleeve comprises opposite ends (80, 80a) that are inserted between the internal walls (64, 64a) formed at the opposite faces of said hollow tube.

7. A sports stick structure according to claim 6, characterized in that said sleeve comprises opposite ends (80a, 80b) that are at least partially bonded to the internal walls (64, 64a) formed at the opposite faces of said hollow tube.

8. A sports stick structure according to claim 1, characterized in that said handle has a longitudinal axis (101), wherein said port has an oval shape to form a pair of arches, the long dimension of said oval shape being oriented along said longitudinal axis.

9. A sports stick structure according to claim 1, characterized in that said hollow tube is made of a composite material or a metal material or a polymeric material.

10. A sports stick structure according to claim 3, characterized in that said sleeve is made of a composite material or a metal material or a polymeric material.

11. A sports stick structure according to claim 1, characterized in that it is an ice hockey stick, a field hockey stick, a lacrosse stick or a floorball stick.

12. A method of forming a sports stick having a handle (12) and a striking end (34), said handle comprising a hollow tube (36) having at least one port (58) extending through opposite faces (22, 22a) of said hollow tube, comprising the steps of:
forming said hollow tube (36) with at least one pair of recessed areas (60, 60a) at opposed faces (22, 22a) of said hollow tube, said recessed areas having bottom walls (66, 66a) and internal walls (64, 64a) that extend towards the interior of said hollow tube; and
removing the bottom walls (66, 66a) of said recessed areas to form a pair of holes (70, 70a), said port being defined at least partially by said the internal walls of said recessed areas.

13. A method of forming a sports stick according to claim 12, further comprising the step of inserting a sleeve (80) between said internal walls.

14. A method of forming a sports stick according to claim 13, further comprising the step of bonding at least partially said sleeve (80) to said internal walls.
